(19) United States
(12) Patent Application Publication
(10) Pub. No.: US 2005/0224001 A1
(43) Pub. Date: Oct. 13, 2005

(54) Method of processing an auditable age record for an animal

(75) Inventors: Bruce L. Golden, Loveland, CO (US); Brian Mowan, Wellington, CO (US); Daniel S. Baker, Fort Collins, CO (US); John W. Cravens, Loveland, CO (US); Justin D. Cobb, Fort Collins, CO (US); David R. Henriksen, Windsor, CO (US)

Correspondence Address: SWANSON & BRATSCHUN L.L.C., 1745 SHEA CENTER DRIVE, SUITE 330, HIGHLANDS RANCH, CO, 80129, US

(73) Assignee: Optibrand Ltd., LLC, Fort Collins, CO (US)

(21) Appl. No.: 11/101,816

(22) Filed: Apr. 8, 2005

Related U.S. Application Data
(60) Provisional application No. 60/561,036, filed on Apr. 8, 2004.

(51) Int. Cl. A01K 1/10

(52) U.S. Cl. 119/51.02

(57) ABSTRACT

A method of processing an auditable age record for an animal. The method includes acquiring an image of select teeth of the animal and associating a date the image was acquired with the image. In addition, the method includes acquiring an image of a specific biometric characteristic of the animal and generating an identification record from the biometric characteristic. In particular, an identification record may be generated from an image of the ocular fundus of the animal. The method also includes creating an auditable age record from input which includes at least the dated image of the select teeth of the animal and the identification record.

### RELATED APPLICATION DATA

This application claims benefit of U.S. Provisional Application Ser. No. 60/561,036, filed Apr. 8, 2004, entitled AN AGING PROCEDURE FOR SLAUGHTER CATTLE USING AUDITABLE RECORDS OF FEEDER CATTLE DENTITION STATUS, which application is incorporated herein by reference in its entirety.

### TECHNICAL FIELD

The present invention is directed toward a method of processing an auditable age record for an animal, and more particularly toward a method of processing an auditable age record including proof of a dentition examination and biometric identification.

### BACKGROUND ART

It is becoming increasingly important in the worldwide livestock industry for livestock producers to maintain accurate age and identification records for each animal produced. The need for suitably detailed and accurate records is driven in part by the increased use of automation in livestock sorting, feeding, and harvesting operations. More importantly, however, is an increase in the occurrence of certain diseases which pose a threat to humans. For example, bovine spongiform encephalopathy (BSE) has been contracted by humans in Europe from cattle. Diseases such as BSE are contracted by eating certain portions of infected livestock. BSE has dramatically impacted the worldwide livestock production industry. Therefore, the need for accurate and verifiable age and identification records associated with livestock is in large part being driven by the emergence of BSE and other diseases.

One illustrative case of the increasing importance of the maintenance of accurate age records for animals arose when regulations in the United States were issued after a single case of bovine spongiform encephalopathy (BSE) was discovered in a single dairy cow in late December, 2003. Shortly after the BSE was identified, the United States Department of Agriculture (USDA) Food Safety and Inspection Service (FSIS) adopted procedures for identifying and processing the carcasses of animals that may be at risk of carrying BSE. The FSIS procedures designate at risk carcasses as being from animals that are older than 30 months at slaughter. Special handling procedures are required for processing these carcasses, which can increase the cost of processing.

In particular, the FSIS, on Jan. 12, 2004, issued guidelines providing that certain portions of all slaughter cattle are specified risk materials (SRMs) which may contain the BSE agent in cattle infected with the disease. SRMs must be disposed of as inedible. In addition, the FSIS notice stated that the carcasses of cattle 30 months of age and older have additional SRMs which must also be disposed of as inedible. Consequently, the USDA veterinary medical officer (VMO) must verify that the carcasses and parts of cattle 30 months of age and older are properly identified and handled. Thus, the maintenance of auditable age records for cattle processed in the United States has become significantly more important after January, 2004.

The FSIS guidelines set forth the following specific VMO responsibilities for age determination:
A. VMOs are to examine establishment records that report the age of cattle because cattle 30 months of age and older contain additional SRMs beyond those for cattle of any age. The documentation may be in the form of:
   1. A birth certificate;
   2. Cattle passport; or
   3. Some other form of identification that is presented with the animal when it arrives for slaughter.
B. If VMOs conclude that the records are accurate and reliable, the records will be accepted as verification of the age of the cattle.
C. If VMOs examine the records and find significant reasons for questioning their validity, or records are not available, they are to verify the age of the cattle through dental examination.
D. VMOs are to consider cattle to be 30 months and older when the examination of the dentition of the animal shows that at least one of the second set of permanent incisors has erupted. FSIS recognizes that the third and fourth permanent incisors of cattle erupt from 24 through 30 months of age, but the Agency has determined that the described dentition procedure will be most protective of public health.
E. VMOs on patrol assignments are to correlate with inspection program personnel at slaughter establishments.

In summary, the FSIS guidelines enforced in the United States describe two methods for age determination. The first method allows for the introduction of documentation or records that show the approximate date of birth of the animals being processed. The VMO is required to make a determination as to whether the records are acceptable at the time of slaughter.

Alternatively, if no documentation or records of age are provided or the VMO does not accept the records at the time of slaughter, age determination is performed by inspecting the lower mandible of an animal and determining the number of permanent incisors present. Specifically, an animal is assigned an age of greater then 30 months when at least one of the third or forth permanent incisors is visible in the oral cavity above the gum line. The FSIS states that this typically occurs on cattle between 24 and 30 months of age. Thus, the FSIS policy is designed to err toward assigning an age that tends to be older than the actual age of the animal. The conservative age estimates employed by the FSIS increases the cost of producing cattle. For example, the additional cost of processing cattle in the United States is estimated to be $65.00 to $85.00 per animal designated as being over 30 months of age. In addition, some packers are reporting discounted prices for cattle over 30 months as high as $250.00/head. Because of the error associated with using the FSIS conservative aging methods, it is likely that many of these animals are falsely identified as being over 30 months of age.

According to the FSIS, acceptable records for age determination may include pregnancy check records, mating records including dates when bulls were put into pastures, artificial insemination records, and calving records. All records require knowledge of the individual animal's birth information from the farm of origin. However, many if not most cattle arrive at a feedlot or sale yard with diffuse information about the farm of origin and birth date.

The FSIS procedure also requires the animals to be individually identified. Conventional methods of individual identification include plastic ear tags or radio frequency based ear tags or implants. Because the VMO is required to make a determination of the admissibility of the records, the potential exists for the VMO to reject the records based, in part, on the ability to easily alter identity using tags. However, ear tags continue to be the de facto standard for individual animal identification.

The problems associated with maintaining an auditable age record for cattle in the United States in response to FSIS regulations is illustrative of problems faced by livestock producers worldwide. Producers of other livestock animals besides cattle face similar challenges. In addition, the cost to producers associated with inaccurate aging methods employed at or near the time of slaughter are relevant to the producers of various livestock animals worldwide.

The present invention is directed toward overcoming one or more of the problems described above.

### SUMMARY OF THE INVENTION

One aspect of the present invention is a method of processing an auditable age record for an animal. The method includes acquiring an image of select teeth of the animal and associating an acquisition date with the image. In addition, the method includes acquiring an image of a specific biometric characteristic of the animal and generating an identification record from the biometric characteristic. In particular, an identification record may be generated from an image of the ocular fundus of the animal. The method also includes creating an auditable age record from input which includes at least the dated image of the select teeth of the animal and the identification record.

The image of the select teeth and the image of the biometric characteristic such as the ocular fundus may be acquired with a digital camera, facilitating communication of digital images to a computer associated with the digital camera. Thus, the auditable age record may be created as a digital record. The input to the auditable age record may be encrypted and the date of the dental image may be directly obtained from a GPS receiver associated with the computer to protect the integrity of the auditable age record. Similarly, the auditable age record, once prepared, may be encrypted.

The method may further include estimating an age of the animal from a field dental examination or examination of the image of the select teeth of the animal. Supplemental data may be associated with the auditable age record such as the identity of the technician preparing the record or the location of the animal which is the subject of the record. Existing animal identification may also be associated with the auditable age record. The existing animal identification information may be obtained as an image of an existing tag or other identification, by scanning data from a bar code associated with any existing animal identification, by receiving data from a radio frequency identification device, or by manually inputting data from any existing animal identification.

The method may further include attaching a new identification tag associated with the auditable age record to the animal and scanning information from a bar code or other machine readable code from the new identification tag into the auditable age record.

The auditable age record may be audited or verified. In particular, the accuracy of the image of the select teeth of the animal may be verified and the accuracy of the identification record based on biometric characteristics may be verified. The verification process may also include decoding the encrypted input or decoding the encrypted auditable age record to verify that the input or resultant record has not been falsified or otherwise tampered with.

### BRIEF DESCRIPTION OF THE DRAWINGS

FIG. 1 is a flowchart detailing one method of processing an auditable age record for an animal in accordance with the present invention;

FIG. 2 is a flowchart detailing an alternative method of processing an auditable age record for an animal in accordance with the present invention;

FIG. 3 is a flowchart detailing an alternative method of processing an auditable age record for an animal in accordance with the present invention;

FIG. 4 is a block diagram of an apparatus suitable for implementation of the present invention;

FIG. 5 is a flowchart detailing a method of processing an auditable age record for an animal in accordance with the present invention specifically directed toward processing cattle in the United States; and

FIG. 6 is a flowchart detailing an alternative method of processing an auditable age record for an animal in accordance with the present invention specifically directed toward processing cattle in the United States.

### DETAILED DESCRIPTION OF THE PREFERRED EMBODIMENT

The preparation and maintenance of accurate age records for livestock animals has become increasingly important in the worldwide livestock industry. Accurate livestock age and identification records are critical as livestock processing becomes more automated. Perhaps more importantly, the appearance of certain livestock diseases which can be transmitted to humans mandate that accurate and auditable livestock identification records be maintained. The risk that a given livestock animal will be contaminated with certain diseases such as bovine spongiform encephalopathy (BSE) increases with age. Thus, many worldwide regulatory industries such as the United States Department of Agriculture (USDA) have implemented processing guidelines and protocols which have restrictions based upon a livestock animal's age. In instances where a livestock animal's age can not be directly and accurately verified, alternative aging procedures such as dental examination may be employed. Typically, the regulations concerning alternative aging procedures are quite conservative, and thus likely to assign an age to a livestock animal which is greater than its actual chronological age. Alternative aging procedures such as dental examination which are employed at or near the time of slaughter increase the cost of producing a livestock animal if restrictions are placed on the use of the animal because of an incorrect designation of age. The present invention is directed toward a method of processing an auditable age record for a livestock animal.

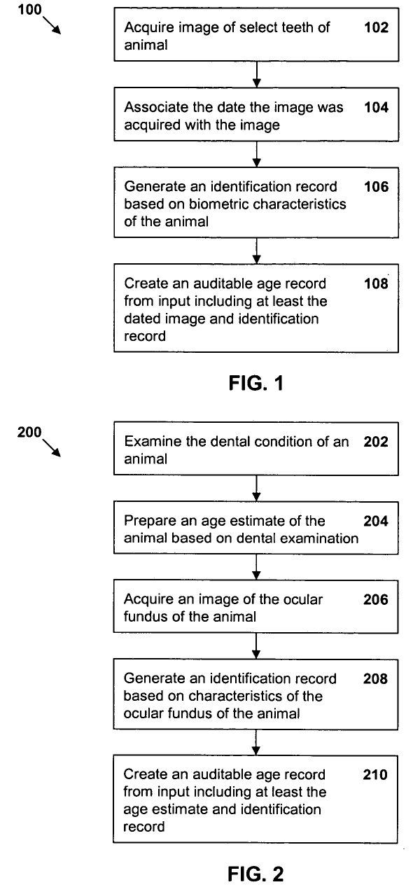

One embodiment of the method of processing an auditable age record for an animal is illustrated in the flowchart of FIG. 1. The method 100 includes acquiring an image of select teeth of the livestock animal (step 102). In addition, the date the image of the select teeth of the animal was acquired is permanently associated with the image (step 104). Next, an identification record is generated for the animal based upon specific biometric characteristics of the animal (step 106). Then, an auditable age record is created from input which includes at least the dated image of the select teeth of the animal and the identification record (step 108).

The method 100 described above with respect to FIG. 1 is implemented in advance of slaughter. Ideally, the method is implemented when the dental condition of the livestock animal presents a reasonably accurate maximum age for the livestock animal. Thus, an auditable age record produced according to the method 100 is less likely to result in an overestimate of the age of a livestock animal than a dentition examination performed at the time of slaughter. Therefore, a livestock producer can avoid costs associated with an overestimate of age at the time of slaughter.

An alternative method 200 of processing an auditable age record for a livestock animal is illustrated in FIG. 2. The method 200 includes examining the dental condition of an animal (step 202) and preparing an age estimate for the animal based upon the dental examination (step 204). In addition, a specific biometric characteristic, an image of the ocular fundus of the animal, is taken (step 206). Subsequently, an identification record based on characteristics of the ocular fundus of the animal is prepared (step 208). A detailed discussion of the method of generating an identification record based on characteristics of an animal's ocular fundus is contained in Golden et al., U.S. Pat. No. 6,766,041, entitled RETINAL VASCULAR IMAGE ACQUISITION APPARATUS AND METHOD, which patent is incorporated herein by reference in its entirety. In addition to generating an identification record, an auditable age record may be created from input including the age estimate from the dental condition of the animal and the identification record (step 210).

The method 200 may include acquiring a dated image of the teeth observed in the dental examination similar to steps 102-104 of the method 100. Alternatively, certification by a veterinarian or other method of authenticating the results of the dental examination may be employed to protect the integrity of the auditable age record.

As discussed above, the present methods of processing an auditable age record for an animal may be applied to any type of livestock production. The method is particularly suitable for the preparation of an auditable age record for cattle as described below. The maintenance of age records for cattle is of particular importance, given the appearance of BSE in certain cattle herds worldwide. The United States Department of Agriculture (USDA), through the Food Safety and Inspection Service (FSIS), has prepared guidelines for processing cattle in response to the threat of BSE. The guidelines include additional processing steps based upon the maximum estimated age of an animal.

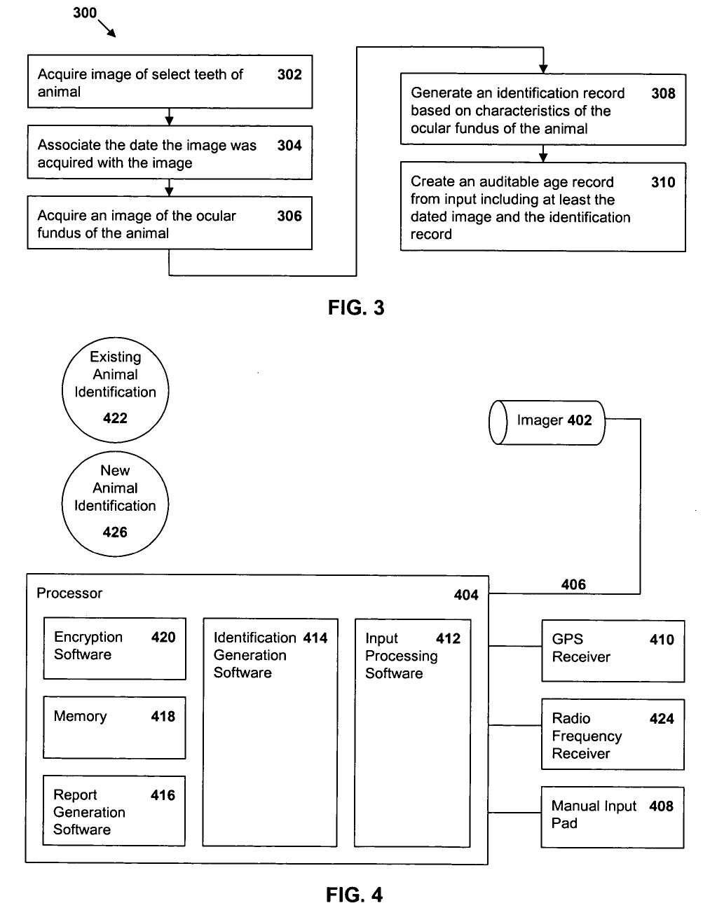

An embodiment of the present method for processing an auditable age record optimized for the cattle industry is illustrated in FIG. 3. The method 300 of processing an auditable age record includes acquiring an image of select teeth of the animal (step 302) and associating a date the image of the select teeth of the animal was acquired with the image (step 304). In addition, an image of the ocular fundus of the animal is acquired (step 306). From the image of the ocular fundus of the animal, an identification record based on characteristics of the ocular fundus of the animal may be prepared (step 308). An auditable age record may be created from input including at least the dated image of the select teeth of the animal and the identification record (step 310).

The images and data of the present methods may be acquired with any suitable apparatus. One representative apparatus suitable for the implementation of the present methods is shown schematically in FIG. 4. An image of select teeth of a livestock animal (steps 102, 302) may be acquired with an imager 402. Preferably, the imager 402 is a digital camera. The image of select teeth may be associated with a date through software running on a processor 404. The processor 404 may be a handheld microcomputer or a larger server located remotely. The link 406 between the processor 404 and the imager 402 may be a short cable, in the case of a handheld processor, or a network, wireless link, or other data link as is customary in the computing arts. The date the image was acquired may be input to the processor 404 through a manual input pad 408 or may be obtained automatically through a global positioning system (GPS) receiver 410 in communication with the processor 404. Input processing software 412 may be associated with the processor 404 for permanently associating the date of the image with the image.

The imager 402 may also be used to acquire an image of biometric identification characteristics of a livestock animal. For example, the imager 402 may be used to acquire an image of the ocular fundus of an animal (steps 206, 306). A precise identification of the livestock animal may be created from the biometric characteristic image by identification generation software 414. For example, an accurate identification record may be generated from the image of an animal's ocular fundus in accordance with the methods set forth in Golden, U.S. Pat. No. 6,766,041.

Report generation software 416 associated with the processor 404 may be used to create an auditable age record from input including at least the dated image of the select teeth of the animal and the identification record (steps 108, 310). The auditable age record may be stored in memory 418 associated with the processor 404. Preferably, the input to the auditable age record, for example the identification record and the dated image of select teeth, will be encrypted by encryption software 420 in conjunction with the creation of an auditable age record. Similarly, the auditable age record itself may be encrypted with encryption software 420 in conjunction with the commitment of the auditable age record to memory 418. The use of encryption plus the acquisition of an image date through the GPS receiver 410 ensures that the auditable age record can not be falsified, tampered with, modified, or otherwise corrupted either accidentally or intentionally. Security measures such as encryption and automatic date stamping are beneficial to preserve and protect the integrity of the auditable age record for subsequent audit purposes as described below.

Various supplemental data may be included in the auditable age record. For example, the technician preparing the auditable age record may estimate an age of the animal by either a field dental examination of the animal or examination of the image of the select teeth. The technician may then associate the estimated age with the auditable age record. Supplemental data, such as the name of the operator or the location of the livestock, may be input to the processor 404 through the manual input pad 408.

Similarly, the livestock may have existing animal identification information 422. This existing animal identification information may contain age and identification information of varying degrees of completeness and reliability. Typically, the existing animal identification will be included on an ear tag attached to the animal or, in some cases, a radio frequency transmitter may be implanted in the animal. Ear tags may have alphanumeric information or, in some instances, be bar coded or otherwise contain digitally accessible information. The imager 402 may be used to obtain and associate an image of any existing animal identification 422 with the auditable age record. The imager 402 in association with appropriate input processing software 412 may also be used to scan bar coded or other digitally stored information. In addition, a radio frequency receiver 424 may be associated with the processor 404 to receive and associate information from an implanted tag or radio transmitter. Alphanumeric information contained on existing animal identification 422 may be associated with the auditable age record by optical character recognition (OCR) functionality associated with the input processing software 412, or alphanumeric information may be directly input to the processor 404 through manual input pad 408.

In conjunction with the preparation of an auditable age record, a new animal identification 426 may be attached to the animal and associated with the auditable age record. Typically, the new animal identification 426 will be a new identification ear tag. If the new animal identification 426 is prepared to display bar code or other machine readable information, the imager 402 and processor 404 may be used to acquire the data from the new animal identification 426 and permanently associate it with the auditable age record.

The present methods of processing an auditable age record are most beneficial if implemented sometime prior to slaughter. Ideally, the implementation of the present methods will set an initial age estimate which results in a more accurate age at the time of slaughter than a mere dental examination at the time of slaughter. The present methods of processing an auditable age record include many features as described above to facilitate an audit of the record at the time of either record preparation or slaughter to verify an animal's stated age.

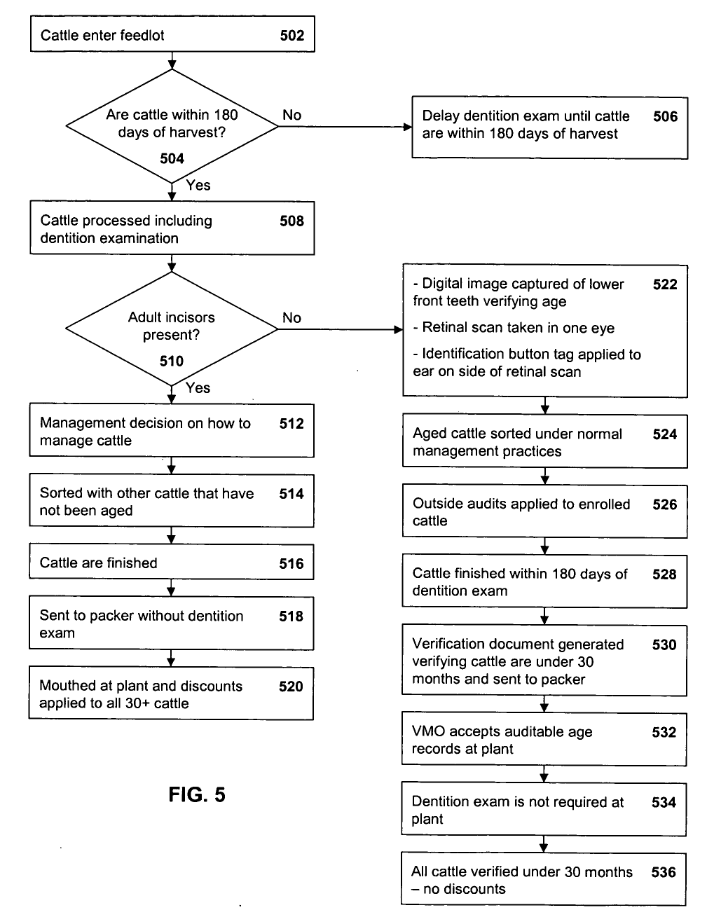

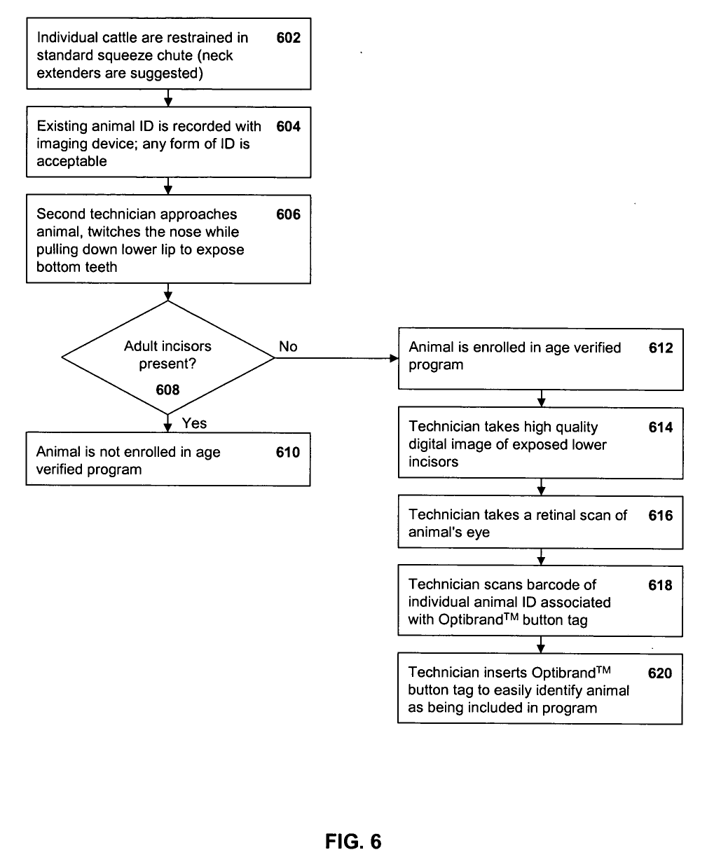

FIGS. 5 and 6 illustrate a specific implementation of the present methods. In particular, FIGS. 5 and 6 illustrate the application of the present methods to the processing of cattle in the United States. The implementation of the present methods as illustrated in FIGS. 5 and 6 is not intended to limit the scope of the present invention. Rather, the implementation of the present methods as shown in FIGS. 5 and 6 is a representative example of one possible implementation of the present methods.

The USDA FSIS regulations designate that carcasses from cattle older than 30 months at slaughter are “at risk.” Special handling procedures are required for the processing of at risk carcasses, which increases the cost of processing. In addition, certain meatpackers require a payment discount as high as $250.00 per animal for at risk carcasses.

Age may be determined under FSIS regulations by the introduction of records that show the approximate date of birth of the animals being processed. Suitable records include pregnancy check records, mating records, artificial insemination records, and calving records. However, many if not most cattle arrive at a feedlot or sale yard with diffuse information about the farm of origin and birth date.

In the absence of direct age records, FSIS regulations require that a USDA veterinary medical officer (VMO) make a determination of age at the time of slaughter. This age determination is performed by inspecting the lower mandible and determining the number of permanent incisors present. Under present regulations in the United States, the presence of at least one of the permanent third or fourth incisors at the time of slaughter is used to designate animals older than 30 months of age. This approach will result in a large number of younger cattle being incorrectly designated as over 30 months of age.

FIG. 5 illustrates a procedure which may be followed to implement the present methods with respect to cattle in the United States. The procedure begins when a producer's cattle enter the feedlot (step 502). At that time, a determination is made whether the cattle are within 6 months or 180 days of harvest (step 504). If the cattle are not within 180 days of harvest, the initial dentition exam may be delayed until the cattle are within 180 days of harvest (step 506). If, however, the cattle are within 180 day of harvest, cattle processing including an initial dentition examination may proceed (step 508).

Whether or not an auditable age record is created may depend upon the results of the initial dentition examination. For example, eruption of at least one of the third or fourth lower permanent incisors typically occurs on cattle between 24 and 30 months of age. Thus, the FSIS guidelines require that an animal be assigned an age of greater than 30 months when at least one of the third or fourth permanent incisors is visible in the oral cavity above the gum line (step 510). Accordingly, if at least one of the third or fourth lower permanent incisors is visible in the oral cavity above the gum line, no benefit is obtained by preparing an auditable age record. A management decision may be made on how to manage cattle that have not been aged (step 512), and the subject cattle may be sorted with other cattle that have not been aged (step 514). Ultimately, the cattle are finished (step 516), sent to the packer without a dentition exam (step 518), and all extra costs or discounts associated with cattle aged over 30 months are applied (step 520).

Alternatively, the initial dentition examination may indicate that no permanent incisors are visible in the oral cavity above the gum line (step 510). In this instance, a scientifically sound determination may be made that the subject cattle is no more than 24 months of age. An auditable age record is necessary to preserve this conclusion.

Thus, a digital image may be captured of the lower front teeth verifying that no permanent incisors are visible, a retinal scan may be taken of one eye, and an identification tag may be applied to the ear on the side of the retinal scan, all in accordance with the method of processing an auditable age record described above (step 522). The aged cattle may be sorted under normal management practices (step 524), and outside audits may be applied to cattle enrolled with an auditable age record (step 526).

The cattle thus enrolled may be finished within 180 days of the dentition exam and preparation of an auditable age record (step 528). When the cattle are sent to the packer, verification documents may be generated verifying that the cattle are under 30 months of age (step 530). Ideally, the VMO will accept the auditable age records prepared as described above at the packing plant (step 532), thus no dentition exam will be required at the plant (step 534), and all cattle accompanied by an auditable age record as described above will be verified as under 30 months, thus no additional costs or discounts will apply (step 536).

The specific steps taken by a technician preparing an auditable age record as described above are set forth in detail in FIG. 6. It should be noted that the steps set forth in FIG. 6 are a specific application of the method of the present invention. The present method is not limited to the specific steps set forth in FIG. 6 or described below with respect to FIG. 6.

The preparation of an auditable age record commences when individual cattle are restrained in a standard squeeze chute, preferably with neck extenders (step 602). Any existing animal identification 422 may be recorded with the imager 402 (step 604). Contemporaneously, a second technician approaches the animal, twitches the nose while pulling down the lower lip to expose bottom the animal's bottom teeth (step 606).

The technician then determines visually whether adult incisors are present (step 608). If adult incisors are present upon visual inspection, the animal is not enrolled in an age verified auditable age record program (step 610). No images are taken, and the animal is finished in accordance with steps 512-520 of FIG. 5.

In the alternative, if no adult incisors are present, the animal is enrolled in an age verified program and an auditable age record is prepared (step 612).

The inputs to the auditable age record may be accurately digitally acquired as shown in steps 614-620. In particular, the technician may take a high quality digital image of the exposed lower incisors (step 614). Ideally, a date is associated with this image through a GPS receiver 410 associated with the processor 404 or other means. The technician may also take a retinal scan of the animal's eye (step 616). The technician may also scan the bar code or other machine readable data associated with the new animal identification 426 (step 618) an attach the new animal identification 426 to the animal to easily identify the animal as being included in an age verified auditable age record program (step 620). Subsequently, enrolled cattle may be finished as indicated in steps 528-536 of FIG. 5.

Outside audits applied to enrolled cattle are an integral part of the specific method as described above, see for example step 526 of FIG. 5. Preferably, auditors will be available to verify that the dentition status of the individual animals is as claimed by the producer. This audit may occur within a few days of the preparation of the initial auditable age record. The auditor can reliably confirm that the dentition examination results are as claimed. In addition, the auditor can verify that the individual identification number on the new animal identification 426 tag is attached to the correct animal by confirming the retinal image.

An auditor may also want to verify that animals being prepared for shipping to a processing facility are in fact the animals that had the dentition exams performed within the 180 days prior to slaughter. Confirming that the retinal vascular pattern of an animal is the same as on the original image for an animal accomplishes this verification. The use of encryption software 420 to prepare the auditable age record assures the integrity of the record. In particular, the feeder or sale yard will not have access to the encryption keys that unlock the encrypted information in the data records for the animals. If an auditor desires to confirm that the data records have not been tampered with, the auditor may be supplied with access to the encryption keys to decode the encrypted information to confirm that the data has not been altered.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

1. A method of processing an auditable age record for an animal comprising:
acquiring an image of select teeth of the animal;
associating a date the image of the select teeth of the animal was acquired with the image;
acquiring an image of the ocular fundus of the animal;
generating an identification record based on characteristics of the ocular fundus of the animal; and
creating the auditable age record from input including at least the dated image of the select teeth of the animal and the identification record.

2. The method of claim 1 wherein the image of the select teeth of the animal and the image of the ocular fundus are acquired with a digital camera, and further comprising:
communicating the acquired digital images to a computer associated with the digital camera; and
creating the auditable age record as a digital record.

3. The method of claim 2 further comprising encrypting the input to the auditable age record.

4. The method of claim 2 further comprising encrypting the auditable age record.

5. The method of claim 2 further comprising obtaining the date the image of the select teeth was acquired through a GPS receiver associated with the computer.

6. The method of claim 1 further comprising:
estimating an age of the animal from one of a field dental examination of the animal and examination of the image of the select teeth of the animal; and
associating the estimated age with the auditable age record.

7. The method of claim 1 further comprising associating supplemental data collection information with the auditable age record.

8. The method of claim 1 further comprising associating existing animal identification information with the auditable age record.

9. The method of claim 8 further comprising:
obtaining an image of any existing animal identification tag; and
associating the image of any existing animal identification tag with the auditable age record.

10. The method of claim 8 further comprising:
scanning data from a barcode associated with any existing animal identification tag; and
associating the data scanned from any existing animal identification tag with the auditable age record.

11. The method of claim 8 further comprising:
receiving data from a radio frequency identification device associated with any existing animal identification tag; and
associating the data received from the radio frequency identification device with the auditable age record.

12. The method of claim 8 further comprising:
observing data associated with an existing animal identification tag; and
manually associating the data observed from any existing animal identification tag with the auditable age record.

13. The method of claim 1 further comprising attaching an identification tag associated with the auditable age record to the animal.

14. The method of claim 13 further comprising:
scanning information from a bar code associated with the identification tag; and
associating the scanned information with the auditable age record.

15. The method of claim 1 further comprising:
verifying the accuracy of the image of the select teeth of the animal; and
verifying the accuracy of the identification record based on characteristics of the ocular fundus of the animal.

16. The method of claim 3 further comprising decoding the encrypted input to the auditable age record to verify the input to the auditable age record has not been tampered with.

17. The method of claim 4 further comprising decoding the encrypted auditable age record to verify the auditable age record has not been falsified.

18. The method of claim 13 further comprising verifying the identification tag attached to the animal is accurately associated with the auditable age record created for the animal.

19. A method of processing an auditable age record for an animal comprising:
acquiring an image of select teeth of the animal;
associating a date the image of the select teeth of the animal was acquired with the image;
generating an identification record based on biometric characteristics of the animal; and
creating the auditable age record from input including at least the dated image of the select teeth of the animal and the identification record.

20. A method of processing an auditable age record for an animal comprising:
examining the dental condition of an animal;
preparing an age estimate for the animal based upon the dental examination
acquiring an image of the ocular fundus of the animal;
generating an identification record based on characteristics of the ocular fundus of the animal; and
creating the auditable age record from input including at least the age estimate and the identification record.
